(19) United States
(12) Patent Application Publication
(10) Pub. No.: US 2008/0247059 A1
(43) Pub. Date: Oct. 9, 2008

(54) Miniature Piezoelectric Motor and Method of Driving Elements Using Same

(76) Inventor: Shuxiang Dong, Blackburg, VA (US)

Correspondence Address: PILLSBURY WINTHROP SHAW PITTMAN LLP, P.O. BOX 10500, MCLEAN, VA, 22102, US

(21) Appl. No.: 12/062,327

(22) Filed: Apr. 3, 2008

Related U.S. Application Data
(60) Provisional application No. 60/921,814, filed on Apr. 3, 2007.

(51) Int. Cl. G02B 7/04; H02N 2/12

(52) U.S. Cl. 359/696; 310/323.06

(57) ABSTRACT

The present invention provides a piezoelectric ultrasonic motors and a method of driving a motor with a standing wave. The motors include a thin ring/cylinder-type stator having one or two piezoelectric (ceramic or single crystal) rings/cylinders, coated with a segmented top/outer electrode and a bottom/inner electrode and poled in a thickness/radial direction, a metal ring/cylinder which is laminated with piezoelectric ring(s)/cylinder(s) having several inner threaded protrusions. The motor also includes a power source for supplying an alternating voltage to one group of electrodes of the piezoelectric stator to excite a standing wave vibration along one diameter direction of the stator ring/cylinder. The motor further includes a short cylinder rotor, which may have a lens inside for certain optical applications, or it may include other elements. The rotor is attached to the stator at the threaded surface of the protrusions and is driven to produce a circular motion, which may also be translated into a linear motion by the threaded surface through standing wave deformation at protrusions. Reverse motion of the rotor can be realized by applying the alternating voltage to another group of electrodes of the stator.

### CROSS-REFERENCE TO RELATED APPLICATIONS

This application claims priority from U.S. Provisional Patent Application No. 60/921,814, filed Apr. 3, 2007, the contents of which are incorporated herein by reference in its entirety.

### FIELD OF THE INVENTION

The present invention relates generally to piezoelectric motors. More particularly, the invention relates to a miniature piezoelectric motor that can drive its rotor and elements coupled thereto in a desired motion, and to a method of configuring and/or controlling such a motor to drive elements such as a lens or group of lenses more precisely and linearly.

### BACKGROUND OF THE INVENTION

Piezoelectric micromotors have many features superior to conventional electromagnetic motors of comparable size, such as relatively higher power density, larger driving force, higher efficiency, faster responses, frictional lock in the power-off condition, and fewer parts in construction. More particularly, piezeolectric motors are capable of providing an actuating component with an outer dimension in the range of a few millimeters and an output torque in μNm's to mNm's, as well as a low power consumption of less than 0.1 Watt within a certain operation duration. Many other new technologies, including voice coil motors, are being developed which can theoretically provide comparable features. But among them, the micro piezoelectric motor has shown higher feasibility in terms of resolution, reliability, power efficiency, and miniaturization.

Piezoelectric ultrasonic motors with sizes of several centimeters have been successfully used in commercial applications such as in conventional camera lens assemblies for auto-focus and auto-zoom. Moreover, efforts have been made to develop piezoelectric motors and actuators with even smaller sizes, which would allow them to be used in other commercial applications such as in camera phone modules, where the motors could drive a lens for auto-focus or auto-zoom. However, the prior art piezoelectric motor designs suffer from many drawbacks that prevent such smaller-sized applications.

For example, a ring-type traveling wave motor or a rod-type wobbling motor is used to drive a camera lens, such as the types of motors developed by Canon, including the motors described in U.S. Pat. No. 5,307,102 to Ohara and U.S. Pat. No. 5,387,835 to Tsukimoto et al. However, these types of motors are too large in size to be feasible for smaller size applications such as camera-phone modules. It would be desirable to have a motor that is more compact in size and more suitable for applications such as driving camera phone lenses.

Another rod-type wobbling motor is a linear ultrasonic lead screw motor (see, e.g., U.S. Pat. No. 6,940,209 entitled, “Ultrasonic Lead Screw Motor” by Henderson). This motor employs a long cylinder-shaped piezoelectric stator with four piezoelectric elements for producing wobbling motions at two ends of nuts to drive a threaded shaft assembly to move in the axial direction. This rod-type motor can be made very small in diameter, but is difficult to be made short in axial length. Furthermore, it has a complex structure and requires a relatively higher operating voltage. Therefore, it would be desirable to have a motor which is short in both diameter and axial length, has a simple structure, and can operate at a relatively low voltage.

A typical configuration for the conventional piezoelectric actuator is a piezoelectric vibratory rod system (see, e.g., U.S. Pat. No. 6,836,057 entitled, “Drive Mechanism Employing Electromechanical Transducer” by Hata) which uses the inertial force and variable frictional mechanism produced by a piezoelectric multilayer element to drive a lens. Although this type of actuator is simple in structure and does not need a large piezoelectric element for driving, it still requires a relatively long rod for producing longitudinal vibrations. In addition, this type of actuator is inefficient, has a weak driving force, and suffers from vibration-sensitive problems. Again, it would be desirable to have a motor with a short axial length, a high efficiency and strong driving force, and is free from vibrations-related problems.

Another typical configuration for the conventional piezoelectric rotational/displacement actuator is a rectangular type L1-B2 two-mode standing wave motor, operated in first longitudinal vibration mode (L1) and second bending mode (B2) (see, e.g., U.S. Pat. No. 6,879,085 entitled, “Resonance Shifting” by Shiv). This piezoelectric stator consists of a rectangular metal plate and four thin piezoelectric plats bounded on said metal plate for exciting L1 and B2 modes, respectively. Although it can be operated at a low working voltage, this type of actuator suffers significantly from problems caused by the difference in resonance frequencies in L1 and B2 modes. Even a slight difference in resonance frequencies of the two modes will result in its failure to operate. It would be desirable to have a motor that remains functional when there is a shifting in the resonance frequencies.

Another piezoelectric motor operating in standing wave motion is a disc-type configuration, described in Akihiro Iino et al, “Development of a self-oscillating ultrasonic micro-motor and its application to a watch,” Ultrasonics 38, 54 (2000). This motor is applied to driving a calendar in a wristwatch, but its configuration is apparently not suited for driving a lens or other element in a linear motion.

Thus, there remains a need in the art for a linear piezoelectric motor or drive device/actuator that is compact in size along the element moving direction, high in power efficiency, with a large driving force under a low working voltage, and is tolerant of a shifting in resonance frequency.

### SUMMARY OF THE INVENTION

The present invention provides a micro/miniature piezoelectric motor, and a method of driving elements such as a lens using such a motor, that solves the above-described problems of the prior art, among others. In embodiments, a piezoelectric motor according to the invention includes a thin ring-shaped stator having at least one piezoelectric ceramic or single crystal ring coated with a top electrode divided into several segments and a bottom electrode. The piezoelectric part is polarized in the thickness direction. The stator ring is a metal ring that is laminated with the piezoelectric ring(s) and has inner facing protrusions. The motor also includes a power source for supplying one alternating voltage to one electrode group to excite standing wave vibrations in the piezoelectric ring in a certain radial direction. In embodiments, the motor can further include a thin and short threaded hollow cylinder as the rotor. An element to be driven, such as a lens or gear, can be mounted on it or inside. This cylinder-type rotor rests on the inner protrusions of the stator, which drives the rotor to rotate via frictional force produced by standing wave deformation at the protrusions. Meanwhile, the threaded surface can help realize a linear displacement of the rotor.

One advantage of the present invention is that the proposed piezoelectric motor has a thin and ring-type configuration, and a lens or other element can be integrated into the center of piezoelectric motor to be driven directly as one part of the rotor. This design allows reducing the overall module size, especially in the thickness direction. Another advantage over the piezoelectric actuators based on the conventional inertial force method is that it has higher power efficiency and driving force due to the standing wave drive and threaded mechanism. A further advantage of the present invention is that when configured with a threaded drive mechanism, the motor is not as sensitive to vibrations as inertial force actuators are. A still further advantage of the present invention is that it is possible that piezoelectric element(s) in the stator can be made into thin type, therefore, the required working voltage for the stator can be very low. A yet further advantage of the present invention is that the piezoelectric motor can provide a driving mechanism for a lens or other element in an integrated structure having fewer components, and hence, a lower fabrication cost.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1A is a top view of a piezoelectric motor having one piezoelectric ring laminated with one metal ring with four inner threaded protrusions and a rotor having a lens inside. The rotor is screwed on the inner threaded protrusions of the stator, forming an integrated motor-lens mechanism;

FIG. 1B is a cross-sectional view taken along diameter line 1B-1B through the piezoelectric motor of FIG. 1A;

FIG. 1C is an enlarged drawing of a portion of FIG. 1B;

FIG. 2A shows the counterclockwise working mode of the motor;

FIG. 2B shows the clockwise working mode of the motor;

FIG. 3 is a cross-sectional view of another embodiment of piezoelectric motor with two piezoelectric rings and a rotor having a lens inside. The rotor is screwed on the inner threaded protrusions of the stator;

FIG. 4 is a cross-sectional view of another embodiment of piezoelectric motor having one multilayered piezoelectric ring and one metal ring with inner threaded protrusions bonded on inner face of the piezoelectric ring, and a rotor having a lens inside. The rotor is screwed on the inner threaded protrusions of the stator;

FIG. 5A is a top view of another embodiment of a piezoelectric motor having one thin and short piezoelectric cylinder on the outer face of a metal cylinder with inner threaded protrusions and a rotor having a lens inside. The rotor is screwed on the inner threaded protrusions of the stator;

FIG. 5B is a cross-sectional view taken along diameter line 5B-5B through the piezoelectric motor of FIG. 5A;

FIG. 6A is a top view of another piezoelectric motor having one piezoelectric ring laminated with one metal ring with four split protrusions, and a rotor having a lens inside. The rotor is screwed on the inner protrusions of the stator;

FIG. 6B is a cross-sectional view taken along diameter line 6B-6B through the piezoelectric motor of FIG. 6A;

FIG. 7A is a top view of another piezoelectric motor having one or two piezoelectric rings laminated with one metal ring, a stator with its entire inner surface being threaded, and a rotor having a lens inside. The rotor is screwed on the inner thread of the stator;

FIG. 7B is a cross-sectional view taken along diameter line 7B-7B through the piezoelectric motor of FIG. 7A;

FIG. 8 is a cross-sectional view of another embodiment of piezoelectric motor without a lens barrel; and

FIG. 9 is a cross-sectional view of another embodiment of piezoelectric motor, where the lens is held by a lens barrel attached to the motor by springs. The lens barrel contact the rotor through ball bearings and can be driven linearly without rotation around the lens axis.

### DETAILED DESCRIPTION OF THE PREFERRED EMBODIMENTS

The present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration. Still further, the drawings are provided for illustration and not limitation or exact reproduction of embodiments of the invention, and they are not necessarily to scale.

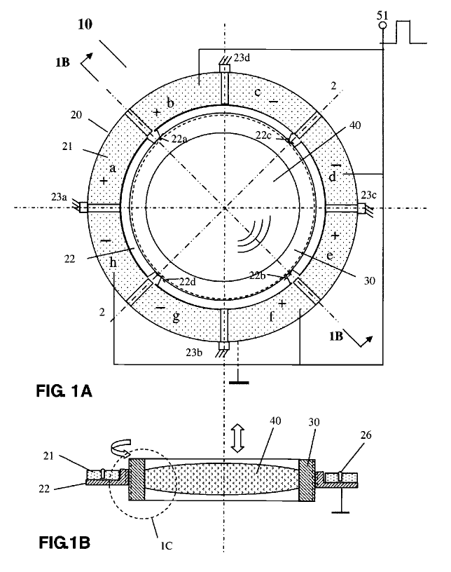

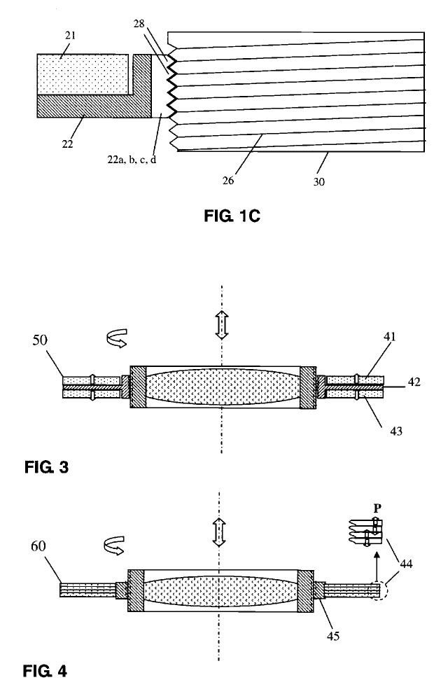

FIGS. 1A and 1B illustrate a first embodiment of a piezoelectric motor according to aspects of the invention. These figures, and certain other of the figures, illustrate the motor of the invention in conjunction with a particular application where the motor is used to drive a lens or group of lenses (e.g. in connection with providing auto-focus or auto-zoom in miniature cameras, such as those in cell phones). However, it should be noted that the invention is not limited to this useful application. For example, the piezoelectric motor principles of the invention can be extended to other applications such as medical imaging (e.g. endoscopes), surgical equipment (e.g. syringes for liquid or drug injections), actuators, displacement control, gas or fluidic valve or switch controls, micro-robots, micro-machines, etc.

FIG. 1A is a side view of piezoelectric motor 10 and FIG. 1B is a cross-sectional view taken along diameter line 1B-1B through the piezoelectric motor 10 of FIG. 1A. As shown, motor 10 includes one ring type piezoelectric stator 20 with four inner facing protrusions, 22a, b, c and d, a threaded cylinder-shaped rotor 30, which is screwed on the inner protrusions 22a, b, c and d of the stator 20, and a driven lens 40 assembled inside the rotor 30. The entire motor can measure from 1 mm to 100 mm in diameter, (typically about 5-9 mm in some preferred embodiments useful for a cell phone camera), from 1 mm to 100 mm in height (typically about 2 mm for a cell phone camera embodiment), and from 0.1 to 100 g in weight (typically about 0.4 g in a cell phone camera embodiment).

As further shown, the piezoelectric stator 20 includes a piezoelectric ring 21 about 0.2 mm in thickness. Ring 21 can be comprised of a ceramic such as Pb(Zr₁₋ₓTiₓ)O₃ (PZT) or it can be comprised of a single crystal material such as Pb(Mg_{1/3}Nb_{1/3})O₃—PbTiO₃ (PMN-PT) or Pb(Zn_{1/3}Nb_{2/3}O)₃—PbTiO₃ (PZN-PT), for example. Stator 20 further includes metal ring 22 comprised of brass, aluminum, steel or stainless steel, for example, about 2 mm thick, which is preferably laminated with piezoelectric ring 21 with a chemical such as epoxy resin. An alternative design involves metallic coating of the electrodes using plate or thin film deposition.

Piezoelectric ring 21 has a bottom electrode and a top electrode. The top electrode is segmented into eight parts, 21a, b, c, d, e, f, g, and h. In other embodiments, the top electrode can be segmented into any even number of parts, such as 4, 6, 8, 10, 12, etc. The operating principles are the same, but for sake of illustration and simplicity, an eight-segment electrode is discussed in detail here but shall not be construed to restrict the scope of the present invention. In the example wherein the top electrode of ring 21 has eight segments as shown in FIG. 1, metal ring 22 further includes protrusions 22a, 22b, 22c and 22d located at the boundary between segments 21a/21b, 21e/21f, 21c/21d and 21g/21h, respectively.

The top electrode segments are divided into two groups, i.e. group A: 21b, d, f and h, and group B: 21a, c, e and g. The top electrode segments are coupled to power supply 51 via bonding wires, for example, while the bottom electrode is coupled to ground through metal ring 22. Accordingly, the piezoelectric ring is polarized along its thickness direction. Arrow 26 in FIG. 1B indicates the positive polarization direction of piezoelectric ring. In the example configuration of FIG. 1, segments 21a, b, e and f are labeled with a plus (+) sign to indicate they are in the positive polarization direction, and segments 21c, d, g and h are labeled with a negative (−) sign to indicate they are in the negative polarization direction.

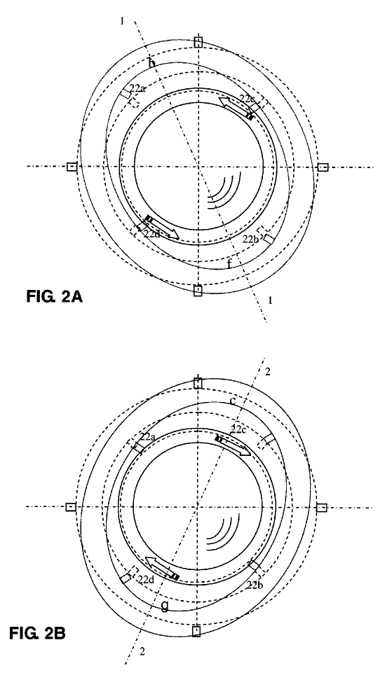

When power supply 51 provides an alternating voltage, for example about 20 Vpp at roughly 30 KHz, and it is applied to one group of electrode segments (e.g. group A) of the piezoelectric ring, 21b, d, f and h as shown in FIG. 1A, the applied voltage will excite a standing wave vibration in stator 20. As will be explained in more detail below in connection with FIGS. 2A and 2B, this response includes an inward deformation of stator 20 at opposite protrusions of the ring, which will impart a frictional force on the rotor and cause the rotor to rotate. Moreover, because of the threaded screw mechanism of this embodiment, the rotor rotation will cause the lens assembly to move linearly along the lens axis or rotor axis. Note that this piezoelectric stator 20 can be softly fixed at positions, 23a, b, c, and d, which prevents standing wave vibration energy loss.

Although not shown in FIG. 1A, when the alternating voltage is applied to the other group (e.g. group B) of electrode segments, 21a, c, e, and g, this will result in the rotor moving in the reverse direction, as will also be described in more detail below in connection with FIGS. 2A and 2B. It should be noted that there are various ways to control which group of electrode segments receives power, and thus to control driving the rotor in the forward or reverse direction. For example, a single power supply 51 can be provided, and an electronic switch or gate can be used to switch between power supply 51 and the electrode groups A and B, so as to control which group of segments receives power from supply 51. Alternatively, separate power supplies can be coupled to the respective groups of electrode segments.

FIG. 1C is an enlarged illustration from a portion of FIG. 1B. As shown in FIG. 1C, in a steady state, threads 26 of rotor 30 rest on protrusions 22a, 22b, 22c and 22d of stator 20. As shown in this example embodiment, protrusions 22a, 22b, 22c and 22d are each comprised of a set of several bumps 28 arranged in a height direction of the motor that respectively engage with threads 26 of rotor 30. As will be described in more detail below, when a voltage is applied to electrodes in piezoelectric ring 21, protrusions 22a, 22b, 22c and 22d will either disengage or frictionally engage with rotor 30, thereby imparting motion to rotor 30.

FIGS. 2A and 2B further illustrate in detail the two standing wave vibration modes mentioned during the discussion of FIG. 1. As shown in FIG. 2A, and as will be understood by those skilled in the art of piezoelectric materials, when an alternating voltage is applied to one group of opposing electrode segments of the piezoelectric ring 21, for example segments 21b and 21f for expanding (or contracting), while 21d and 21h for contracting (or expanding) due to their reverse polarization direction, a standing wave along the 1-1 diameter direction of the ring can be excited. This in turn produces small elliptical deformations of ring 21, measured at approximately 0.1 to 10 micrometers at opposing protrusions 22c and 22d of the stator, respectively. This deformation causes the protrusions 22c and 22d to urge against the rotor with a frequency corresponding to the frequency of the alternating voltage of power supply 51. It should be noted that when the protrusions urge toward the rotor, they are slightly angled with respect to a normal angle due to the elliptical deformation, which will cause the rotor 30 to move in a counterclockwise rotation within the threaded grooves 22 of the stator 20. Since the rotor-lens assembly is fixedly attached to the threads of the stator, this rotation drives the rotor-lens both rotationally within the stator and linearly along the lens axis.

In one example embodiment, each periodic contact between stator 20 and rotor 30 will cause a rotation of rotor 30 of less than about 0.1 degree and a linear motion of less than 1 μm. Moreover, with a working frequency of about 30 kHz, and an appropriate thread pitch, the linear motion of the lens assembly will be about 0.1 to 2 mm/sec.

Because the elliptical motion stretches the stator along the directions of protrusions 22a and 22b, these two protrusions are disengaged from the rotor and will not cause a counter-acting force. However, as shown in FIG. 2B, when the alternating voltage is applied to the other two pairs of opposing electrode segments (21c and 21g for expanding (or contracting), while 21a and 21e for contracting (or expanding) due to their reverse polarization direction), this will excite a standing wave vibration in the direction of diameter 2-2, which has a 45 degree angle to the 1-1 diameter, and will produce an elliptical deformation at the other pair of opposing protrusions, 22a and 22b. Now the diagonally perpendicular protrusions 22c and 22d are disengaged and will not counteract. The end result of the voltage being applied to the other group of electrode segments is the rotor 30 moving in the reverse, or clockwise, direction.

It should be noted that in the above-mentioned prior art patent of Henderson, a long rod-type ultrasonic lead screw motor was described, in which the motor was operated in first bending mode and the threaded shaft was driven to produce a linear motion via a wobbling motion at the two ends of the tube-type piezoelectric stator. In the same prior invention, the lens was attached to a spring piece, and the motor's shaft drove this spring piece through a ball. Clearly, the present invention piezoelectric motor's operating principles are completely different from those in Henderson. The lens-driving mechanism in the present invention is also much simpler due to the integrated motor-lens configuration design.

FIG. 3 illustrates a cross-sectional view of another embodiment of a piezoelectric motor with a lens mounted inside of the rotor, according to the present invention. This motor has the same working principles and lens-driving mechanism as those shown in FIGS. 1A and 1B. The only difference is that the stator 50 of the motor shown in FIG. 3 has two thin piezoelectric rings 41 and 43 and a metal ring 42 which is sandwiched between the piezoelectric rings. This makes it possible for the motor to work at lower voltages. In addition, the use of the bi-piezoelectric rings can prevent any unnecessary or unexpected bending mode.

FIG. 4 illustrates a cross-sectional view of another embodiment of the piezoelectric motor and its lens-driving mechanism, according to the present invention. Stator 60 of this embodiment includes a piezoelectric ring 44 that is made of multiple layers of piezoelectric rings with sufficient thickness and stiffness so that the metal ring 45 can be directly bonded with the inner surface of the piezoelectric ring 44 to achieve a more efficient drive for the rotor and lens. The working principles and lens-driving mechanism are the same as those shown in FIGS. 2A and 2B. Another advantage of adopting this multilayered design for the piezoelectric ring is that the required operating voltages can be lowered significantly.

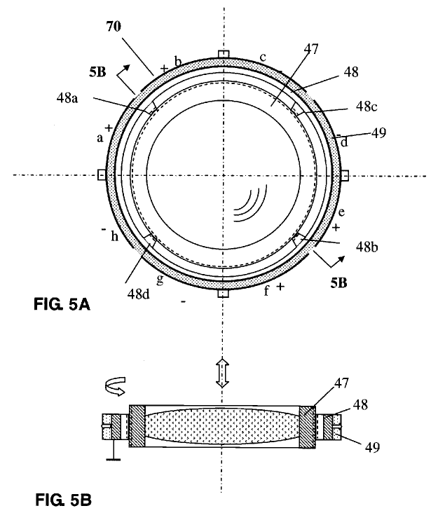

FIG. 5A illustrates another embodiment of a piezoelectric motor having one cylinder-shaped piezoelectric stator 70 with four inner threaded protrusions 48a, b, c, and d, and a cylinder-type rotor 47 with an outer threaded surface and an enclosed driven lens assembled inside of the rotor. FIG. 5B is a cross-sectional view taken along diameter line 5B-5B through the piezoelectric motor. The piezoelectric stator includes a piezoelectric ring and a concentric metal ring 48, which is in tight contact with the inner surface of the piezoelectric ring 49 with the aid of a bonding chemical such as epoxy resin. The rotor 47 is screwed onto the inner surface of the stator, and they contact at the four protrusions 48a, 48b, 48c and 48d on threaded surface. Differently from the polarization orientation in previous embodiments, the piezoelectric ring has an inner electrode and an outer electrode that is segmented into eight parts, and is polarized along its radial thickness direction. When an alternating voltage is applied to two pairs of opposing electrode segments of the piezoelectric stator ring, a standing wave vibration along one diameter direction of the ring stator can be excited. This standing wave produces an elliptical deformation at one pair of opposing protrusions, which in turn drives the rotor and the lens to move axially, as illustrated earlier. Rotation in the other direction can be produced in a similar controlled manner by applying the alternating voltage to the other two pairs of electrode segments of the stator ring. The concentric configuration allows the piezoelectric stator to be smaller in diameter than that of other embodiments shown in FIGS. 1-4, while still supporting a rotor-lens assembly of the same diameter.

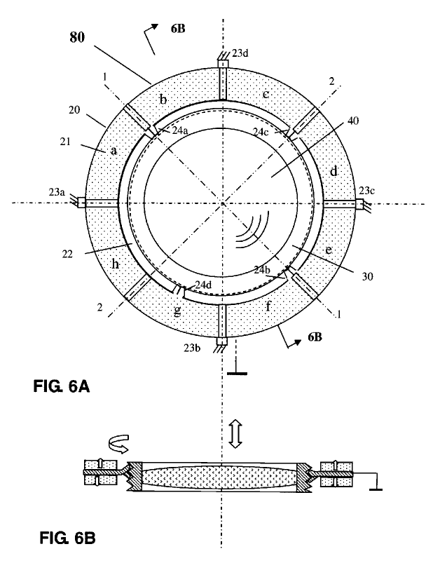

FIGS. 6A and 6B show another embodiment of piezoelectric motor of the present invention. The difference from the previous designs in FIGS. 1-5 is that the metal ring of the stator 80 has four split protrusions instead of threaded ones, and the rotor 30 is threaded on the split protrusions.

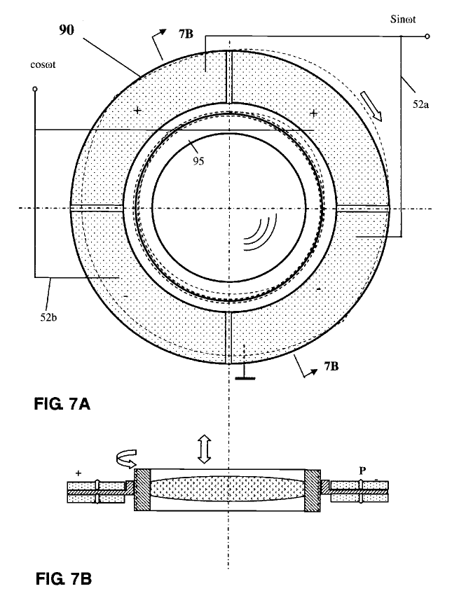

FIGS. 7A and 7B illustrate yet another embodiment of the piezoelectric motor in the present invention. The distinguishing feature here is that this motor uses a stator 90 with threads on its entire inner surface, which is in full contact with the rotor 30. The motor uses a two-phase power supply 61 and 62 to excite a traveling wave to drive the rotor.

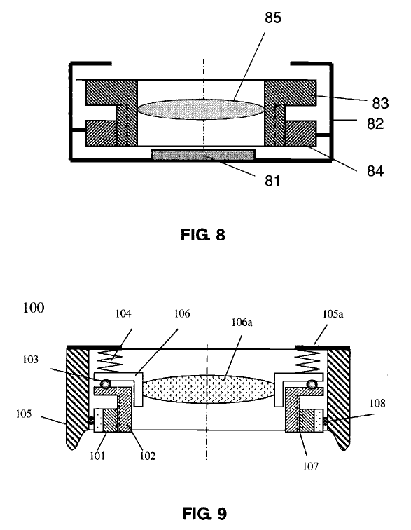

With the motor disclosed in this invention, an example of camera module with auto-focus function is presented in FIG. 8. The camera module consists of an image sensor 81, motor rotor 83, motor stator 84, lens 85, and module housing 82. In cases such as this, the lens is mounted inside the rotor and thus moves spirally together with the motor rotor. The rotor acts as the lens barrel, thereby eliminating a dedicated lens barrel as a component. The simpler and lighter structure can enhance reliability, driving speed, and fabrication cost.

But in some cases, it may be preferable that the lens move linearly without any rotation around the lens axis, for example, to avoid any unnecessary transverse effect, and a lens barrel may be added to the motor. FIG. 9 shows such a camera module where the lens moves linearly driven by the same motor. In this design, the piezoelectric motor 100 having one ring-shaped spring 104 that is attached to a cylinder-shaped case 105 to hold the lens barrel 106 and lens 106a. The piezoelectric stator 101, which is also attached to case 105 via a soft rubber ring 108, drives the rotor 102 up and down in a spiral motion. This is achieved because of the threaded surface 107 between the rotor and the stator, and it then drives the lens-and-barrel assembly linearly via the ball bearings 103. Although ball bearings are used in this design to realize the lens move linearly while the motor rotates, other mechanisms can achieve the same linear movement of the lens, such as lubrication of the contact surface between the lens barrel and rotor. In this design, springs 104 are placed on top of the lens barrel 106 and held by end caps 105a. The function of the springs are threefold: 1) to allow the lens move linearly; 2) to prevent lens rotation; and 3) to induce some load between the rotor and stator, which helps to keep constant the friction between rotor and stator. A constant friction between rotor and stator will help the motor operate more stably and predictably.

In other cases, it may be desirable to rotate the lens without any linear movement along the linear axis. For example, a circular polarizing filter (polarizer) may need to be rotated a certain angle while remaining on the same spatial plane to achieve an optical effect. This can be achieved by replacing the threaded contact area between the rotor and the stator in FIGS. 1-8 with one or more parallel, flat grooves. The grooves, or flat circular cavities, can be made on either the outer surface of the rotor, or on the inner surface of the stator. If they are made on the outer surface of the rotor, then a matching number of protruding rings that sit into the grooves can be made on the inner surface of the stator. Similarly, the grooves can be etched on the inner surface of the stator, in which case a matching protruding pattern would be made on the outer surface of the rotor. In either case, the flat groove/ring configuration allows the rotor to rotate freely while holding the rotor in place without any linear movement.

As noted above, and as will be understood by those skilled in the art, where linear movement of the rotor assembly is desired, the linear speed per rotation can be designed by changing the thread design, including the number of threads, spacing, pitch, power supply frequency, etc.

It should be further noted that sometimes it may be preferable to move a single rotor at different linear speeds under the same rotational speed. That is, for each revolution of the rotor, the linear displacement of the rotor varies. This can be accomplished by etching a variable threaded surface between the rotor and the stator, for example. That is, the distance between two grooves of the thread does not stay constant. The variable thread patterns can be etched onto either the inside surface of the stator, or the outside surface of the rotor. Under either approach, some protruding thread or teeth on the other surface secures the rotor to the stator.

Compared with the prior art, the piezoelectric motors of the present invention provide many advantages. For example, as compared to ultrasonic lead screw motors, the advantages include that they allow an integrated motor/lens design with fewer components (2 or 3), a simpler structure that can weigh less than 420 mg, direct lens-driving, and lower working voltages (<20 Vpp). Moreover, compared with inertial force actuators in the prior art, the motors of the present invention can have a higher efficiency and driving force, and they are not as sensitive to vibrations due to the screw mechanism. Moreover, the present invention provides a thin configuration of lens drive mechanism with reduced size and is more suitable for miniature camera module applications. Another advantage of the current invention is a lower fabrication cost due to the lower number of components.

Although the present invention has been particularly described with reference to the preferred embodiments thereof, it should be readily apparent to those of ordinary skill in the art that changes and modifications in the form and details may be made without departing from the spirit and scope of the invention. It is intended that the appended claims encompass such changes and modifications.

What is claimed is:

1. A piezoelectric motor comprising:
a stator having a piezoelectric ring including a bottom electrode and a segmented top electrode; and
a rotor that is rotatably mounted within the piezoelectric ring of the stator;
wherein when an alternating voltage is applied to certain of the segmented electrodes of the stator, a standing wave vibration is induced in the piezoelectric ring which causes the rotor to rotate.

2. A motor according to claim 1, wherein the piezoelectric ring is poled in a thickness direction.

3. A motor according to claim 1, wherein the top electrode is segmented into eight parts, and wherein the alternating voltage is applied to two pairs of the eight electrode segments to induce the standing wave vibration.

4. A motor according to claim 1, wherein the piezoelectric ring is comprised of Pb(Zr1−xTix)O3 (PZT).

5. A motor according to claim 1, wherein the piezoelectric ring is comprised of one of Pb(Mg1/3Nb2/3)O3-PbTiO3 (PMN-PT) and Pb(Zn1/3Nb2/3O)3-PbTiO3 (PZN-PT).

6. A motor according to claim 1, wherein the stator further includes a metal ring having inner protrusions that couples with the rotor in specific locations and is laminated with the piezoelectric ring.

7. A motor according to claim 6, wherein the rotor includes thread on an outer surface that engages with the inner protrusions of the metal ring.

8. A motor according to claim 1, further comprising a lens assembly coupled to the rotor.

9. A motor according to claim 1, further comprising:
a power source that applies two pairs of alternating voltages to certain pairs of the top electrodes to excite a traveling wave vibration along a circumferential direction of the stator ring.

10. A motor according to claim 1, wherein the stator further comprises a metal ring coupled to piezoelectric ring and having several pairs of split protrusions to hold and thread the rotor.

11. A motor according to claim 1, wherein the stator further comprises a metal ring that includes protrusions that engage with corresponding threads of the rotor, thereby further causing the rotor to further move in a linear direction corresponding to the rotation with respect to the stator.

12. A motor according to claim 11, further comprising a lens assembly coupled to the rotor.

13. A motor according to claim 11, further comprising a lens assembly coupled to the rotor via bearings such that the lens assembly only moves in the linear direction in accordance with the rotor, but does not rotate in accordance with the rotor.

14. A rotor drive method using a piezoelectric motor, comprising:
creating a standing wave deformation in a piezoelectric stator of the motor;
rotatably coupling the stator to a rotor,
wherein the deformation of the piezoelectric stator drives the rotor to rotate.

15. A method according to claim 14, further comprising:
applying an alternating voltage to certain electrodes of the piezoelectric stator for producing the standing wave deformation, thereby driving the rotation of the rotor in one rotational direction; and
applying the alternating voltage to certain other of the electrodes of the piezoelectric stator, thereby driving the rotation of the rotor in a reverse rotational direction.

16. A method according to claim 14, wherein the step of rotatably coupling the stator and rotor includes providing a mutually engaging threaded coupling between the stator and rotor, the method further comprising:
applying an alternating voltage to certain electrodes of the piezoelectric stator for producing the standing wave deformation, thereby driving the rotation of the rotor in one rotational direction, and causing the rotor to linearly move in one direction via the threaded coupling between the stator and rotor; and
applying the alternating voltage to certain other of the electrodes of the piezoelectric stator, driving the rotation of the rotor in a reverse rotational direction, and causing the rotor to linearly move in a reverse direction via the threaded coupling between the stator and rotor.

17. A method according to claim 14, further comprising:
mounting an element to the rotor, wherein the rotation of the rotor causes the element to rotate.

18. A method according to claim 14, further comprising:
coupling an element to the rotor in such a fashion that the rotation of the rotor causes the element to move linearly but not to rotate.

19. A method according to claim 16, further comprising:
mounting an element to the rotor, wherein the linear movement of the rotor causes the element to linearly move in a corresponding direction.

20. A method according to claim 19, wherein the element includes a lens.
